(19) United States
(12) Patent Application Publication
(10) Pub. No.: US 2005/0147326 A1
(43) Pub. Date: Jul. 7, 2005

(54) Pixellated image data sub-sampling

(75) Inventors: Jean Nicolai, Chateauneuf Le Rouge (FR); Marie Rimpault, Orsay (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.A., 92120 Montrouge (FR)

(21) Appl. No.: 10/500,314

(22) PCT Filed: Dec. 27, 2002
(86) PCT No.: PCT/FR02/04580

(30) Foreign Application Priority Data
Dec. 28, 2001 (FR) 01/17032

(51) Int. Cl. G06K 9/32

(52) U.S. Cl. 382/299

(57) ABSTRACT

A method and a circuit for sub-sampling pixelized image data gathered in overlapping blocks, comprising reading, line by line, from an image memory containing the pixelized image, accumulating as many lines as provided by the sub-sampling ratio in the vertical direction, using as many accumulator groups as there are blocks in the horizontal image direction and as many accumulators per group as provided by the sub-sampling ratio in the horizontal direction, and memorizing the accumulated values in as many result memories as there are accumulator groups, each result memory containing sub-sampled matrixes of a number of blocks corresponding to the number of overlapping blocks in the vertical direction.

The present invention relates to digital image processing and more specifically to the sub-sampling of digital images. A sub-sampling amounts to approximating a pixelized original image to reduce its size.

Most often, such a sub-sampling is performed regularly in terms of dimensions, that is, a resulting value is made to correspond to a pixel group of given dimensions, the number of pixels in the group being constant for the entire image. The set of resulting values forms a matrix that can be related to an image of reduced dimensions. The data contained by this matrix generally correspond to an average value depending on the original image data (for example, grey level or level in a given color, etc.).

The present invention more specifically applies to the sub-sampling of digital images divided into overlapping blocks. In the sense of the present invention, it is considered that blocks overlap if the number of pixels separating the origins of the two blocks is smaller than the sub-sampling ratio in the vertical direction and/or in the horizontal direction. The sub-sampling ratio corresponds to the number of pixels taken to calculate a single resulting value.

An example of application of the present invention relates to the fractal coding of digital images and more specifically to the step of sub-sampling the so-called domain blocks of such a fractal coding.

Fractal image coding comprises searching, in a digital image, portions of this image that can be considered as being identical after having, if necessary, undergone simple transformations (symmetry, rotation) called isometries.

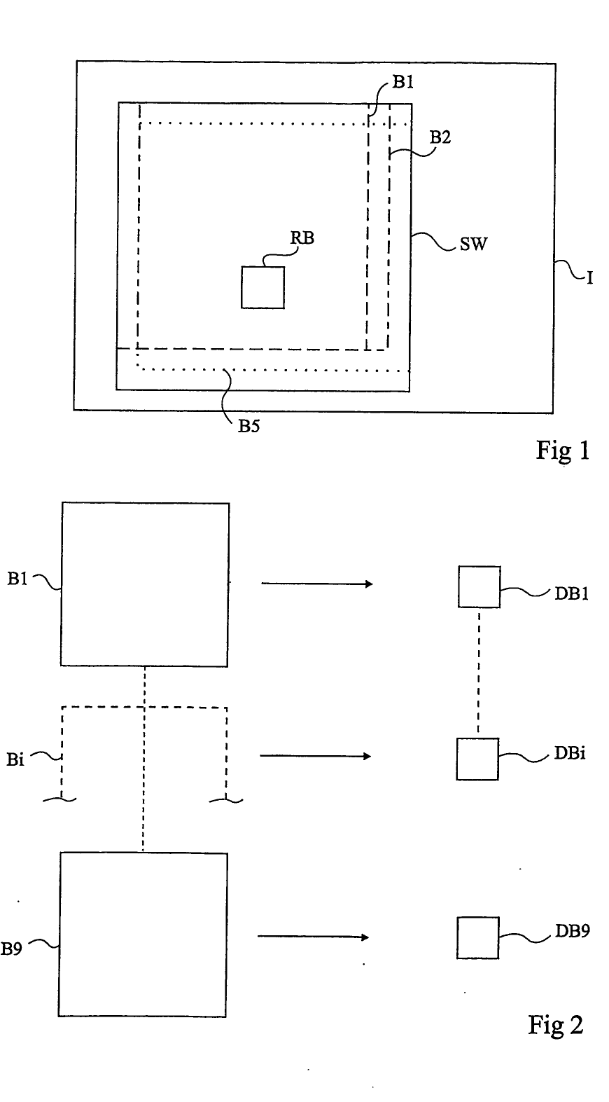

FIG. 1 shows an image I to be submitted to a fractal coding and illustrates the division of this image.

A search window SW in which it is desired to determine if image portions may relate to a reference block RB of the image is first defined in image I. The search window corresponds, at most, to the size of image I.

To obtain image blocks, called domain blocks, to be compared with the reference image, image blocks of larger dimensions B1, B2, etc. are sub-sampled to be brought to the size desired for the domain blocks. The size of the domain blocks corresponds to the size of the searched reference block, generally called “range”. For example, the reference block and the domain blocks correspond to 8*8 matrixes while blocks B taken in the search window are blocks of 32*32 pixels.

FIG. 2 illustrates the sub-sampling performed from blocks B1, Bi, B9 to obtain reduced domain blocks DB1, DBi, DB9.

In a fractal coding method, overlapping original blocks are selected in the search window, which is indispensable to determine the possible identity of the domain blocks, with respect to the reference blocks or their isometries, across the entire search window.

The comparison of the domain blocks and of the reference blocks is performed either by pixel-to-pixel grey level difference or by adding the differences of the squares between the respective values of the domain and reference blocks.

Digital image fractal coding is an image compression technique used to reduce the volume of image transmissions. Rather than sending all the blocks of an image, for similar blocks, the reference block is only sent once, followed by the number of this block and of its possible isometry to define the similar domain blocks.

The fractal image coding or compression technique is described, for example, in work “Fractal image compression: Theory and application to digital images” by Yuval Fisher, published by Springer Verlag, New-York, 1995. Another example of a fractal image compression algorithm is described in article “Design of an ASIC architecture for high speed fractal image compression” by Ancarani De Gloria and Olivieri Stazzone, published in IEEE “International ASIC conference”, September 1996.

Those skilled in the art can also refer to French patent application 2,775,812.

The number of operations and of memory accesses to be performed to sub-sample the blocks of the search window to obtain the domain blocks is very high. Indeed, a sequential reading, pixel by pixel, from a memory containing the pixel values of the search window, is conventionally performed to isolate the different blocks and calculate their respective sub-sampled values.

The sampling includes calculating the average of the individual values of the pixels of the sub-blocks to be sub-sampled. In other words, the respective values of the pixels of each sub-block (for example, the sixteen values of the sub-blocks of 4*4 pixels, referring to the preceding example) are added and the result is divided by the number of pixels of the sub-blocks to obtain the average value as the sub-sample value.

It has already been provided, to reduce the number of memory accesses, to keep the intermediary sums to only perform four extractions of pixel values for each new sampled value.

Sequentially extracting the sixteen values of each sub-block of the image memory requires, even while keeping the intermediary sums, performing for each pixel of the domain blocks (thus, sub-sampled) sixteen memory accesses, sixteen additions, and one division.

The present invention aims at providing a novel method and system for sub-sampling overlapping digital images which reduce the number of memory accesses and of calculations necessary to obtain the sub-sampled images.

The present invention also aims at providing a solution which can adapt to different sub-sampling ratios and image dimensions.

The present invention also aims, without excluding a software implementation, at providing a solution enabling a particularly simple hardware implementation.

To achieve these and other objects, the present invention provides a method for sub-sampling pixelized image data gathered in overlapping blocks, including the steps of:

reading, line by line, from an image memory containing the pixelized image;

accumulating as many lines as provided by the sub-sampling ratio in the vertical direction, using as many accumulator groups as there are blocks in the horizontal image direction and as many accumulators per group as provided by the sub-sampling ratio in the horizontal direction; and

memorizing the accumulated values in as many result memories as there are accumulator groups, each result memory containing sub-sampled matrixes of a number of blocks corresponding to the number of overlapping blocks in the vertical direction.

According to an embodiment of the present invention, the memorization is performed in an interlaced fashion.

According to an embodiment of the present invention, the accumulated values are divided by the product of the sub-sampling ratios in both directions, to obtain average values to be memorized as sub-samples.

According to an embodiment of the present invention, the division of an accumulated value of several lines of the image memory to obtain an average value is obtained by only taking into account a number of most significant bits, smaller than the number of bits of the result value.

According to an embodiment of the present invention, the lines of the image memory are read successively from the first one for a number of lines corresponding to the sub-sampling ratio in the vertical direction, after which the first following line and a previously-used line are alternately read.

The present invention also provides a circuit for sub-sampling pixelized image data distributed in overlapping blocks, including:

a number of adders corresponding to the number of result block pixels in a first direction, multiplied by the number of blocks in a second direction;

a number of accumulators identical to the number of adders; and

a number of result memories of the sub-sampled values corresponding to the number of blocks in the first direction.

According to an embodiment of the present invention, the accumulators are controllable for addition or subtraction of a current value to the previously-accumulated result.

According to an embodiment of the present invention, the number of inputs of each adder corresponds to the sub-sampling ratio in the first direction.

According to an embodiment of the present invention, said result memories include a number of lines corresponding to the number of blocks in the second direction, multiplied by the number of pixels of the result blocks in the second direction.

According to an embodiment of the present invention, the number of bits of a result value stored in one of said result memories is smaller than the number of bits of the values of the pixelized image data, the difference between the two numbers of bits defining the division ratio for obtaining the average value of the pixels of each sub-sampled group.

The foregoing objects, features and advantages of the present invention will be discussed in detail in the following non-limiting description of specific embodiments in connection with the accompanying drawings, in which:

FIGS. 1 and 2, previously described, illustrate an example of an image and of a sub-sampling to which the present invention applies; and

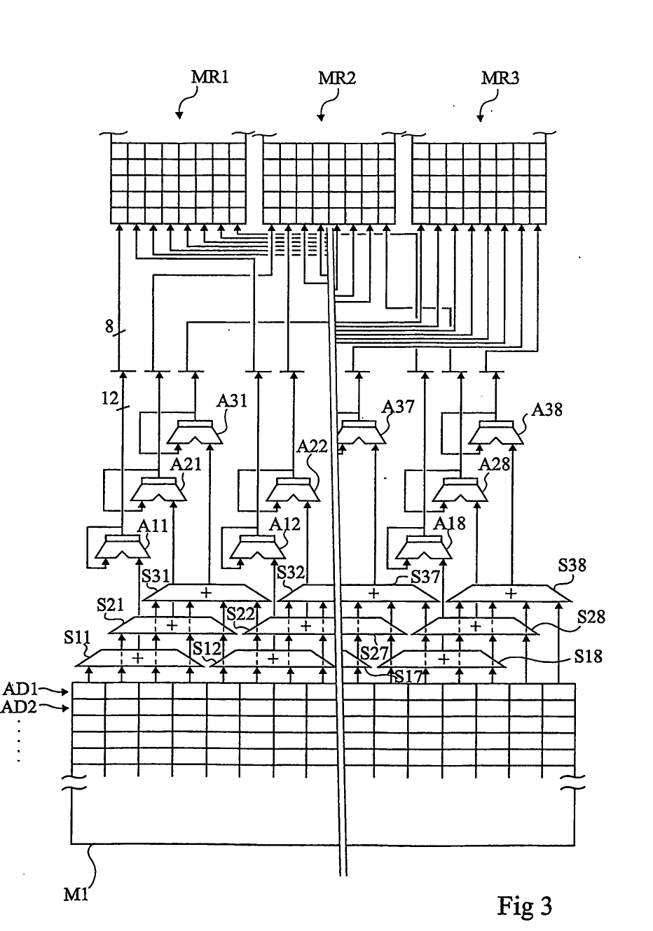

FIG. 3 shows an embodiment of an image block sub-sampling circuit according to the present invention.

Same elements have been designated with same references in the different drawings. For clarity, only those circuit elements and those method steps which are necessary to the understanding of the present invention have been shown in the drawings and will be described hereafter. In particular, the image processing upstream and downstream of the implementation of the method of the present invention has not been illustrated and are no object of the present invention. Further, the circuits for addressing the memories used by the present invention have not been detailed, being within the abilities of those skilled in the art based on the functional indications of the present invention.

A feature of the present invention is to organize the sub-sampling of the overlapping blocks of an image by simultaneously processing all values of the pixels of the search window. Thus, according to the present invention, a memory containing the values of the pixels of the search window, in a matrix arrangement similar to that of the image, is addressed simultaneously for all its columns, to simultaneously process an entire line. Accordingly, the scanning of the memory according to the present invention is performed line by line.

Another feature of the present invention is to process, in parallel, the sub-sampling of the overlapping blocks in the line direction. In other words, as many series of arrangement operators as there are overlapping blocks in the line direction are provided.

The present invention will be described hereafter in relation with an example of application to the sub-sampling of blocks of a search window to obtain domain blocks in a fractal coding of an image. It should however be noted that the present invention more generally applies to any sub-sampling of image blocks overlapping in at least one direction.

To simplify, reference will be made to lines and columns respectively corresponding to the horizontal and vertical image directions. It should however be noted that these notions of direction are arbitrary and may be inverted without changing the principles of the present invention.

FIG. 3 shows an example of architecture of a circuit for sub-sampling an image memory according to the present invention. In this example, the case of a search window SW such as illustrated in FIG. 1, that is, comprised of 34 columns and 34 lines, is considered. The search window is comprised of 9 blocks of 32*32 pixels which must be sub-sampled in 9 domain blocks of 8*8 pixels. In practice, a larger search window, for example, of 64 by 64 pixels, is used. To simplify, the present invention will be described in relation with a search window of 34 by 34 pixels. It however applies whatever the number of pixels of the search window and of the blocks.

The sub-sampling correspond, as previously, to taking the average of groups of 16 pixels (4*4) of each block to form a pixel of the resulting domain block.

The case of an image in levels of grey will be considered hereafter. Obtaining the average thus amounts to adding the respective levels of grey of the pixels of each group and of dividing the obtained number by the number of pixels. As an alternative, the division may be omitted if the multiplication factor of the number of pixels of each group is taken into account in the reference block (RB, FIG. 1).

A sub-sampling circuit according to the present invention includes as many inputs as the search window to be processed includes columns, that is, as many inputs as there are memory words per line to be processed.

According to the present invention, blocks B1 to B9 are processed 3 by 3 to minimize the number of operations to be executed. The 3 by 3 processing corresponds to the number of block overlappings present in the search window in each direction.

For each series of blocks, as many adders as there are average values in each line of the domain block are provided. Referring to the preceding example, a line of adders S11 to S18 is provided for the first group of blocks B1, B4, and B7 to be processed. Each adder S11 to S18 receives as an input four values sampled from memory M1. Each adder S11 to S18 is associated at its output to an accumulator A11 to A18 intended to add the successive values of the lines of each pixel group forming an average value of the concerned domain block.

According to the present invention, the accumulators are controllable to increment or decrement the accumulated value with the current value. In FIG. 3, accumulators Aij (i representing the line to which the accumulator or the adder belongs, and j representing the horizontal rank of the average value of the concerned domains) have been symbolized by two-input blocks, a first input being looped back on the output while a second input is connected to the output of the corresponding adder Sij. The accumulators are controllable not only in a configuration of addition or subtraction of the current value, but also in a reset configuration, if necessary.

Referring to the example of the processing of the search window of FIG. 1, the first line of adders S11 to S18 is connected to the respective columns 1 to 32 of memory M1. The second line of adders S21 to S28 is connected to the respective columns 2 to 33 of memory M1. The third line of adders S31 to S38 is connected to the columns 3 to 34 of memory M1.

According to a preferred embodiment of the present invention, the division is performed by only taking a given number of most significant bits of the result obtained in the accumulators. The retained number of bits depends on the desired division factor. In the case of a binary word over 12 bits and of a division by 16, only the 8 most significant bits of the obtained result are taken. This amounts to performing a division by sixteen, rounded to the smallest integer. Such a division mode is particularly simple and has the remarkable advantages of requiring no calculation circuit and no cycle time to perform the calculation. The price to pay is an approximation by a lower value. Such an approximation is however not prejudicial since the result in all cases is a sub-sampling. In FIG. 3, the selection of the 8 most significant bits has been illustrated by cuttings of the connections of the accumulators to the memories. The selection amounts to only taking 8 wires out of the 12 connection wires.

According to the present invention, the results of the respective accumulators are stored in three result memories MR1, MR2, MR3 (or three areas of a same memory) corresponding to the obtained domain blocks gathered in columns. The storage in the result memories is performed each time an accumulator contains a complete value. This synchronization is performed by means of a control circuit which will be described functionally hereafter.

The result obtained in this memory preferably corresponds to the domain blocks stored in interlaced fashion, the reading from the result memories being then adequately controlled to properly restore the domain blocks. As an alternative, the reading will be performed line by line but the storage of the results of the accumulators in the different memories is controlled as appropriate. The embodiment corresponding to an interlaced storage simplifies the recording since it is enough to increment the addresses of the result memories of a unit for each new recording.

The addressing of memory M1 is performed, preferably, line by line (addresses AD1, AD2, etc.).

According to the present invention, the control of the sub-sampling circuit is performed as follows.

The first line of memory M1 is first read and the respective sums provided by adders Sij are added in the respective accumulators Aij previously reset to zero.

The second, third, and fourth lines of memory M1 are then successively read and the sums by groups of four columns by means of circuits Sij are added to the preceding values of the accumulators Aij. At the end of the fourth line, the first value lines of domain blocks D1, D2, and D3 are obtained in the respective accumulators.

These values are then stored in the first lines of result memories MR1, MR2, and MR3, respectively.

The average values which are then calculated correspond to the first lines of domain blocks D4, D5, and D6. For this purpose, the first line of memory M1 is first reread, and the respective sums by groups of four columns of the levels of grey are subtracted from the values previously accumulated in accumulators Aij. They then contain the accumulation of lines 2, 3, and 4. The fifth line of memory M1 is then read, and added to the content of accumulators Aij by groups of four columns. The result of the accumulators (lines 2, 3, 4, and 5) is then unloaded towards the respective second lines of memories MR1, MR2, and MR3, possibly undergoing the division.

The next average value calculation step consists of subtracting the second line of memory M1 and of adding the sixth line. The obtained result then corresponds to the first line of average values of domain blocks D7, D8, and D9.

To calculate the average values of the second line of domain blocks D1, D2, and D3, two solutions are possible. A first solution comprises resetting the accumulators and of successively reading positively accumulated lines 5, 6, 7, and 8 to form the searched average values. A second solution comprises rereading lines 3 and 4 to subtract them from the precedingly accumulated values, then reading lines 7 and 8 and adding them to the accumulator results. Whatever the solution, this step requires four calculation and memory access cycles.

The second solution however is a preferred embodiment since it enables simplification of the sequencing algorithm of the sub-sampling circuit control. Indeed, this solution respects the succession of subtraction and addition steps in the accumulators. It is enough to start with subtracting line 3 and adding line 7, then subtracting line 4 and adding line 8.

The above-described sequencing carries on for the rest of memory M1, to obtain the last line of domain blocks D7, D8, and D9 corresponding to the last reading of line 34 of memory M1.

The total number of calculation cycles necessary to sub-sample the entire memory in the above example is 64 cycles (corresponding to the number of pixels of a sub-sampled block). Cycle means the time period necessary to perform an addressing and a reading of the datum from the memory as well as the corresponding addition. This addition is however performed with no time consumption since it can be performed by means of simple logic gates. The cycle time more generally corresponds to the memory access time plus the addition and accumulation time.

The number of 64 cycles indicated hereabove is to be compared with a number of 16×9×64 cycles necessary in case of an addressing of a memory by sub-groups of 16 pixels (4×4) to calculate the successive average values in the conventional case.

An advantage of the present invention is that it enables considerably reducing the number of memory accesses and the time required to sub-sample a search window.

Another advantage of the present invention is that it is particularly simple to implement by hardware means with simple circuits.

Of course, the present invention is likely to have various alterations, modifications, and improvements which will readily occur to those skilled in the art. In particular, although the present invention has been described hereabove in relation with an example of application to a fractal coding search window, it more generally applies whatever the size of the search window and the number of overlapping image blocks to be sub-sampled. Generally, considering an image or search window of n*m pixels defining the size (number of lines and number of columns) of memory M1, and assuming blocks to be sub-sampled of p*q pixels with p<n and q<m, the implementation of the present invention can be described as follows. It must first be assumed that the blocks of p*q pixels overlap or cover one another, that is, number k of blocks in the vertical alignment is greater than n/p and number 1 of blocks in the horizontal alignment is greater than m/q. Number k defines the number of interlaced blocks in each result memory MR. Number 1 defines the number of result memories, and thus of adder lines and of accumulator lines. The number of columns of the result memories, which corresponds to the number of adders and of accumulators per line, is a function of the desired sub-sampling ratio in the horizontal direction, as well as of the number of inputs of each adder. The total number of adders and accumulators thus corresponds to the number of pixels of the result blocks in the horizontal direction multiplied by the number of blocks in the vertical direction. The desired sub-sampling ratio in the vertical direction is controlled by the circuit controlling the unloading of the accumulators into the result memories. The number of lines of each result memory corresponds to the number of blocks in the vertical direction, multiplied by the dimension (p) of the block in the vertical direction and divided by the sub-sampling ratio in this vertical direction, and thus to the number of blocks in the vertical direction multiplied by the number of pixels of the result blocs in the vertical direction.

The practical realization of the sub-sampling circuit and of its selectors and control circuits is within the abilities of those skilled in the art based on the functional indications given hereabove. Further, the implementation of the present invention for other applications than those described as an example is also within the abilities of those skilled in the art based on the functional and generalization indications given hereabove.

Finally, the present invention applies whatever the data to be processed contained in the image memory. It may be levels of grey in the case of black and white images or color levels, or data relative to the contrast of the different pixels. The number of bits of each memory word representing a pixel depends on the application and is not critical in the sense of the present invention. Further, the last lines of the image memory may undergo a specific processing for the case where the sizes of the blocks to be sub-sampled result in a number of lines that does not exactly fit into the image memory. The same may be done for the last columns.

1. A method for sub-sampling pixelized image data gathered in overlapping blocks, comprising:
reading, line by line, from an image memory containing the pixelized image data;
accumulating as many lines as provided by a sub-sampling ratio in a vertical direction, using as many groups of accumulators as there are blocks in a horizontal image direction and as many accumulators per group as provided by the sub-sampling ratio in the horizontal direction; and
memorizing the accumulated values in as many result memories as there are accumulator groups, each result memory containing sub-sampled matrixes of a number of blocks corresponding to a number of overlapping blocks in the vertical direction.

2. The method of claim 1, wherein the memorization is performed in an interlaced fashion.

3. The method of claim 1, further comprising dividing the accumulated values by a product of the sub-sampling ratios in both directions, to obtain average values to be memorized as sub-samples.

4. The method of claim 3, wherein the division of an accumulated value of several lines of the image memory to obtain an average value is obtained by only taking into account a number of most significant bits, smaller than a number of bits of a result value.

5. The method of claim 1, wherein the lines of the image memory are read successively from a first one for a number of lines corresponding to the sub-sampling ratio in the vertical direction, after which a first following line and a previously-used line are alternately read.

6. A circuit for sub-sampling pixelized image data distributed in overlapping blocks, comprising:
a number of adders corresponding to a number of result block pixels in a first direction, multiplied by a number of blocks in a second direction;
a number of accumulators identical to the number of adders; and
a number of result memories of sub-sampled values corresponding to the number of blocks in the first direction.

7. The circuit of claim 6, wherein the accumulators are controllable for addition or subtraction of a current value to a previously-accumulated result.

8. The circuit of claim 6, wherein a number of inputs of each adder corresponds to a sub-sampling ratio in the first direction.

9. The circuit of claim 6, wherein said result memories include a number of lines corresponding to the number of blocks in the second direction, multiplied by the number of pixels of the result blocks in the first direction.

10. The circuit of claim 6, wherein a number of bits of a result value stored in one of said result memories is smaller than a number of bits of the values of the pixelized image data, a difference between the two numbers of bits defining a division ratio for obtaining an average value of pixels of each sub-sampled group.

11. An apparatus, comprising:
a first memory to store pixelized image data arranged in overlapping blocks;
a plurality of adders coupled to the memory and having input terminals to receive first values from the first memory that correspond to the stored pixelized image data and to output second values;
a plurality of accumulators respectively coupled to an output terminal of the adders to obtain third values based at least in part on second values output from their respective adders; and
at least one second memory coupled to output terminals of the accumulators to store the third values obtained by the accumulators as domain blocks having a reduced size relative to the overlapping blocks.

12. The apparatus of claim 11 wherein the plurality of adders have a number that corresponds to a number of result block pixels, of the stored pixelized image data, in a first direction, multiplied by a number of blocks of the pixelized image data in a second direction.

13. The apparatus of claim 12, further comprising a plurality of additional second memories, the second memories corresponding in number to a number of blocks in the first direction.

14. The apparatus of claim 11 wherein a number of the accumulators is identical to a number of the adders.

15. The apparatus of claim 11 wherein only certain output terminals of the accumulators provide the third values to the second memory.

16. The apparatus of claim 11 wherein the accumulators are coupled to receive, at one of their input terminals, the third values from their output terminals.

17. The apparatus of claim 11 wherein the accumulators are controllable to add or subtract a current value from a previously obtained value.

18. The apparatus of claim 12 wherein a number of input terminals of each adder to receive the first values from the memory corresponds to a sub-sampling ratio in the first direction.

19. The apparatus of claim 12 wherein the second memory includes a number of lines corresponding to the number of blocks in the second direction, multiplied by a number of result block pixels.

20. The apparatus of claim 11 wherein the third values stored in the second memory include sub-sampled matrices of a number of blocks corresponding to a number of blocks of the pixelized image data in a certain direction.
